(19) United States
(12) Patent Application Publication
(10) Pub. No.: US 2008/0074585 A1
(43) Pub. Date: Mar. 27, 2008

(54) Liquid crystal panel and liquid crystal display device

(75) Inventor: Hiroyuki Yoshimi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/898,117

(22) Filed: Sep. 10, 2007

(30) Foreign Application Priority Data
Sep. 21, 2006 (JP) 2006-256060
Dec. 6, 2006 (JP) 2006-329069

(51) Int. Cl. G02F 1/1335

(52) U.S. Cl. 349/96

(57) ABSTRACT

A liquid crystal panel of the present invention has a liquid crystal cell, a visible-side polarizer disposed on the visible surface side of the liquid crystal cell, and an antivisible-side polarizer disposed on the side opposite to the antivisible surface of the liquid crystal cell. The visible-side polarizer and the antivisible-side polarizer are disposed so that the absorption axis direction of the visible-side polarizer and the absorption axis direction of the antivisible-side polarizer will be approximately parallel to each other. A polarization rotating layer that rotates linearly polarized light by approximately 45 degrees is disposed between the visible-side polarizer and the antivisible-side polarizer.

This liquid crystal panel hardly undergoes distortion and can restrain leakage of light in the peripheral part. Therefore, a liquid crystal display device incorporating the liquid crystal panel is excellent in image displaying characteristics.

### BACKGROUND OF THE INVENTION

1. Field of the Invention

The present invention relates to a liquid crystal panel and a liquid crystal display device.

2. Description of the Related Art

Conventionally, a liquid crystal panel of a liquid crystal display device generally includes a liquid crystal cell, a polarizer disposed on a visible surface side of the liquid crystal cell (the polarizer disposed on the visible surface side may be referred to as a “visible-side polarizer”), a polarizer disposed on a side opposite to the visible surface of the liquid crystal cell (the polarizer disposed on the opposite side may be referred to as an “antivisible-side polarizer”), and an optical compensating layer disposed between the aforesaid two sheets of the polarizers.

The two sheets of the polarizers are arranged in crossed nicols. For example, in a case of a liquid crystal panel of a TN (Twist Nematic) mode, a visible-side polarizer 31a is disposed so that an absorption axis direction A9a thereof will be at an angle of approximately 135 degrees relative to a longer side direction L of a liquid crystal cell 21, whereas an antivisible-side polarizer 41b is disposed so that an absorption axis direction A9b thereof will be at an angle of approximately 45 degrees relative to the aforesaid longer side direction L (perpendicular to the absorption axis direction A9a of the visible-side polarizer 31a), as shown in FIG. 6B.

As the polarizer, a polyvinyl alcohol based stretched film dyed with iodine is widely used. Such a stretched film generates an absorption axis in a main stretching direction.

Meanwhile, the above-described polarizer can shrink or expand in the stretching direction (hereinafter “shrinkage or expansion” will be generally referred to as “expansion-shrinkage”) because of change in the temperature or humidity at the time of use of the liquid crystal panel.

As a result of this, the visible-side polarizer will shrink or expand in parallel to the direction of approximately 135 degrees relative to the longer side direction of the liquid crystal cell, whereas the antivisible-side polarizer will shrink or expand in parallel to the direction of approximately 45 degrees relative to the longer side direction of the liquid crystal cell (approximately 90 degrees relative to the expansion-shrinkage direction of the visible-side polarizer). For this reason, a deformation stress is applied in different diagonal directions on the front and back surfaces of the liquid crystal cell, whereby the peripheral part of the liquid crystal panel will be distorted. The distorted liquid crystal panel generates leakage of light or the like at the peripheral part, so that improvement thereof is demanded.

Conventionally, it is known in the art to prevent warpage of a liquid crystal panel by establishing a predetermined relationship between the thickness of the visible-side polarizing plate and the thickness of the antivisible-side polarizing plate made of a polyvinyl alcohol-based polarizing film provided with a transparent protective layer (Japanese Patent Application Laid-Open No. 2002-207211).

Also, there is known in the art to use in a liquid crystal panel a polarizing plate in which the combined thickness of the polarizer and the protective film is set to be 135 μm or less; a resin layer is provided as an interlayer between the polarizer and the protective film or on the surface of the polarizing plate; and the dimension change ratio in the absorption axis direction is 0.40% or less (Japanese Patent Application Laid-Open No. 2002-372621). All of these means are effective for preventing warpage of the liquid crystal panel.

In recent years, however, the liquid crystal panel has an extremely increased size. For this reason, the problem of distortion of the liquid crystal panel due to the expansion-shrinkage of optical films such as a polarizing plate has not yet been sufficiently solved, so that further improvement is demanded.

### SUMMARY OF THE INVENTION

An object of the present invention is to provide a liquid crystal panel and a liquid crystal display device capable of restraining leakage of light in the peripheral part by preventing distortion of the liquid crystal panel. Another object of the present invention is to provide a liquid crystal panel capable of comparatively increasing the size of a visible surface and an opposite surface. Still another object of the present invention is to provide a liquid crystal panel that can be preferably applied to a liquid crystal cell of a TN mode.

A liquid crystal panel of the present invention comprises:

a liquid crystal cell;

a visible-side polarizer disposed on a visible surface side of the liquid crystal cell; and

an antivisible-side polarizer disposed on a side opposite to the visible surface of the liquid crystal cell, wherein

the visible-side polarizer and the antivisible-side polarizer are disposed so that an absorption axis direction of the visible-side polarizer and an absorption axis direction of the antivisible-side polarizer are approximately parallel to each other, and

a polarization rotating layer that rotates linearly polarized light by approximately 45 degrees is disposed respectively between the visible-side polarizer and the liquid crystal cell and between the antivisible-side polarizer and the liquid crystal cell.

Here, the term “rotation of linearly polarized light by approximately 45 degrees” is used to include a meaning that the polarization plane of the linearly polarized light is rotated clockwise or anticlockwise by 45 degrees±5 degrees with the line perpendicular to the plane of the polarization rotating layer serving as a central axis.

A preferable liquid crystal panel of the present invention is such that the visible-side polarizer and the antivisible-side polarizer are disposed so that the absorption axis direction of the visible-side polarizer and the absorption axis direction of the antivisible-side polarizer will be approximately parallel to a longer side direction of the liquid crystal cell.

As described above, in a conventional liquid crystal panel, the visible-side polarizer shrinks or expands in the direction of approximately 135 degrees relative to the longer side direction of the liquid crystal cell, whereas the antivisible-side polarizer shrinks or expands in the direction of approximately 45 degrees relative to the longer side direction of the liquid crystal cell. For this reason, a deformation stress is generated in different diagonal directions on the front and back surfaces of the liquid crystal cell, thereby giving a cause of distortion of the peripheral part of the liquid crystal cell.

Regarding this point, in the above-described liquid crystal panel of the present invention, the visible-side polarizer and the antivisible-side polarizer are disposed in the liquid crystal cell so that an absorption axis direction of the visible-side polarizer and an absorption axis direction of the antivisible-side polarizer will be approximately parallel to each other. For this reason, the visible-side polarizer and the antivisible-side polarizer can shrink or expand in the same direction in accordance with a change in the temperature or humidity at the time of use of the panel. Therefore, the stress applied to the liquid crystal cell by expansion-shrinkage of the two polarizers will be applied in the same direction on both surface sides of the liquid crystal cell, whereby the distortion at the peripheral part of the liquid crystal panel can be prevented.

In particular, a liquid crystal panel having a comparatively large-scale visible surface also has a large area of the polarizers, so that the problem of warpage caused by expansion-shrinkage of the polarizers is liable to occur; however, the liquid crystal panel of the present invention can effectively prevent the distortion even with the comparatively large-scale visible surface.

Another liquid crystal panel of the present invention comprises:

a liquid crystal cell;

a visible-side polarizer disposed on a visible surface side of the liquid crystal cell; and

an antivisible-side polarizer disposed on a side opposite to the antivisible surface of the liquid crystal cell, wherein

the visible-side polarizer is disposed so that an absorption axis direction of the visible-side polarizer will be approximately perpendicular to or approximately parallel to a longer side direction of the liquid crystal cell,

the antivisible-side polarizer is disposed so that an absorption axis direction of the antivisible-side polarizer will be approximately perpendicular to the absorption axis direction of the visible-side polarizer, and

a polarization rotating layer that rotates linearly polarized light by approximately 45 degrees is disposed respectively between the visible-side polarizer and the liquid crystal cell and between the antivisible-side polarizer and the liquid crystal cell.

A preferable liquid crystal panel of the present invention is such that the visible-side polarizer is disposed so that the absorption axis direction thereof will be approximately parallel to the longer side direction of the liquid crystal cell.

In the above-described other liquid crystal panel of the present invention, the absorption axis direction of the visible-side polarizer is disposed approximately in the perpendicular direction (or approximately in the parallel direction) relative to the longer side direction of the liquid crystal cell, and the absorption axis direction of the antivisible-side polarizer is disposed approximately in a direction perpendicular to the absorption axis direction of the visible-side polarizer (in other words, approximately in the parallel direction (or approximately in the perpendicular direction) relative to the longer side direction of the liquid crystal cell). For this reason, in accordance with a change in the temperature or humidity at the time of use of the panel, the visible-side polarizer can shrink or expand approximately in the perpendicular direction (or approximately in the parallel direction) relative to the longer side direction of the liquid crystal cell, and the antivisible-side polarizer can shrink or expand approximately in the parallel direction (or approximately in the perpendicular direction) relative to the longer side direction of the liquid crystal cell. Therefore, as compared with the above-described conventional liquid crystal panel, the distortion in the peripheral part of the liquid crystal cell can be prevented.

A preferable liquid crystal panel of the present invention is such that the liquid crystal cell is in a normally white mode.

A preferable liquid crystal panel of the present invention is such that the liquid crystal cell is in a TN mode.

Also, a preferable liquid crystal panel of the present invention is such that the visible-side polarizer and the antivisible-side polarizer include a stretched film that generates an absorption axis in a main stretching direction.

When the visible-side polarizer and the antivisible-side polarizer include a stretched film in this manner, the visible-side polarizer and the antivisible-side polarizer are liable to shrink or expand to a great extent in the main stretching direction by a change in the temperature or humidity at the time of use. Regarding this point, according to the present invention, even if the two polarizers include a stretched film, the distortion of the liquid crystal panel can be effectively prevented by the above-described function.

Further, a preferable liquid crystal panel of the present invention is such that the visible-side polarizer and the antivisible-side polarizer include a stretched film containing the same resin as a major component.

When the visible-side polarizer and the antivisible-side polarizer contain the same resin as a major component in this manner, the expansion-shrinkage behaviors of the visible-side polarizer and the antivisible-side polarizer will be similar to each other at the time of use of the panel. Therefore, the distortion of the liquid crystal panel can be prevented with more certainty.

Also, a preferable liquid crystal panel of the present invention is such that the liquid crystal cell is formed in a rectangular shape, the visible-side polarizer and the antivisible-side polarizer include a stretched film having a main stretching direction in the absorption axis direction, and the visible-side polarizer and the antivisible-side polarizer are disposed so that an absorption axis direction of the visible-side polarizer and an absorption axis direction of the antivisible-side polarizer will be approximately parallel to a longer side of the liquid crystal cell.

Such a liquid crystal panel can not only prevent the generation of distortion but also increase the scale of the visible surface size in production.

Specifically, a polarizer including a stretched film is obtained by performing a stretching process on a long film source. The absorption axis of such a polarizer including a stretched film is generated in the stretching direction.

In the above-described liquid crystal panel in which the visible-side polarizer and the antivisible-side polarizer are disposed so that the absorption axis direction of the visible-side polarizer and the absorption axis direction of the antivisible-side polarizer will be approximately parallel to the longer side direction of the liquid crystal cell, the polarizers can be cut out from the film source so that the longitudinal direction of the film source will correspond to the longer side direction of the liquid crystal panel.

Therefore, the liquid crystal panel of the present invention will be such that the maximum length of the liquid crystal panel in the shorter side direction will correspond to the length of the film source in the width direction, so that the visible surface size and the antivisible surface size can be increased to have a greater scale.

Further, a preferable liquid crystal panel of the present invention is such that the polarization rotating layer is a ½ wavelength plate.

Preferably, the ½ wavelength plate has a refractive index property of any one of nx₁>ny₁>nz₁, nx₁>ny₁≈nz₁, and nx₁>nz₁>ny₁.

Here, nx₁ represents a refractive index in an X-axis direction in a plane of the ½ wavelength plate, ny₁ represents a refractive index in a Y-axis direction in the same plane, and nz₁ represents a refractive index in a direction perpendicular to said X-axis direction and Y-axis direction, wherein the X-axis direction is an axis direction in which the refractive index attains a maximum value in the plane, and the Y-axis direction is a direction perpendicular to an X-axis in the plane.

Preferably, the polarization rotating layer has a liquid crystal material that has been subjected to cholesteric orientation. The polarization rotating layer contains 0.005 to 0.1 part by weight of a chiral agent with respect to 100 parts by weight of a nematic liquid crystal material.

Further, a preferable liquid crystal panel of the present invention is such that an optical compensating layer showing a predetermined retardation is disposed between the visible-side polarizer and the antivisible-side polarizer.

Preferably, the optical compensating layer includes a slant orientation layer formed of a material exhibiting an optically negative uniaxial property, and the aforesaid material is in slant orientation in the thickness direction.

As a material showing an optically negative uniaxial property, a discotic liquid crystalline compound can be used, for example.

Preferably, the optical compensating layer including the slant orientation layer is disposed respectively between the visible-side polarizer and the liquid crystal cell and between the antivisible-side polarizer and the liquid crystal cell.

Also, according to another aspect of the present invention, a liquid crystal display device is provided. The liquid crystal display device includes any one of the above-described liquid crystal panels.

The liquid crystal display device of the present invention can restrain leakage of light in the peripheral part caused by distortion of the liquid crystal panel. For this reason, the liquid crystal display device is excellent in image displaying characteristics.

### BRIEF DESCRIPTION OF THE DRAWINGS

FIG. 1 is a schematic longitudinal cross-sectional view showing one embodiment of a liquid crystal display device of the present invention;

FIG. 2 is a central part omitted longitudinal cross-sectional view showing one embodiment of a liquid crystal panel of a TN mode of the present invention;

FIG. 3 is a reference exploded perspective view showing an arrangement state of each layer of a “liquid crystal panel (TN mode) of parallel arrangement type” of the present invention;

FIG. 4 is a reference exploded perspective view showing an arrangement state of each layer of a “liquid crystal panel (TN mode) of perpendicular arrangement type” of the present invention;

FIG. 5 is a reference perspective view showing a rotation direction of linearly polarized light by a polarization rotating layer;

FIG. 6A is a reference perspective view showing a fabrication process of a polarizer used in a conventional liquid crystal panel, and FIG. 6B is a reference exploded perspective view showing an arrangement of a liquid crystal cell, a visible-side polarizer, and an antivisible-side polarizer in a conventional liquid crystal panel;

FIG. 7A is a reference perspective view showing a fabrication process of a polarizer used in a “liquid crystal panel (TN mode) of parallel arrangement type” of the present invention, and FIG. 7B is a reference exploded perspective view showing an arrangement of a liquid crystal cell, a visible-side polarizer, and an antivisible-side polarizer in the liquid crystal panel; and

FIG. 8A is a reference perspective view showing a fabrication process of a polarizer used in a “liquid crystal panel (TN mode) of perpendicular arrangement type” of the present invention, and FIG. 8B is a reference exploded perspective view showing an arrangement of a liquid crystal cell, a visible-side polarizer, and an antivisible-side polarizer in the liquid crystal panel.

### DETAILED DESCRIPTION OF THE PREFERRED EMBODIMENTS

### <Construction Example of Liquid Crystal Panel>

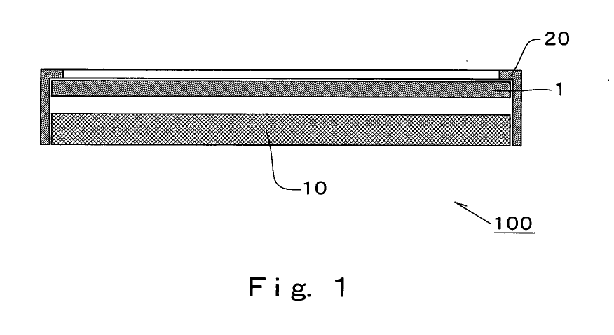

FIG. 1 shows one example of a liquid crystal display device 100 including a liquid crystal panel of the present invention.

The reference numeral 1 represents a liquid crystal panel; the reference numeral 10 represents a light unit disposed to face the liquid crystal panel 1; and the reference numeral 20 represents a bezel disposed around the liquid crystal panel 1.

The light unit 10 is what is known as a back light unit disposed on the opposite side of the liquid crystal panel 1.

Liquid crystal display device can roughly be divided into transmissive type, reflective type and semitransmissive type by the disposition of a light source.

A liquid crystal panel of transmissive type is one in which a light source (a back light) is disposed on the back side of the liquid crystal cell. A liquid crystal panel of transmissive type transmits light of this back light to perform image display. A liquid crystal panel of reflective type is one in which a light source (a front light) is disposed on the visible side of a liquid crystal cell, or a light source (a side light) is disposed on the screen lateral side thereof. A liquid crystal panel of reflective type reflects light of the front light and the like by a reflecting plate to perform image display.

Also, among the liquid crystal panels of reflection type, there is one in which a reflecting electrode is disposed on a substrate, whereby images are displayed by reflecting the light coming from a light source (external fluorescent lamp or solar light) on the visible surface side of the liquid crystal cell.

A liquid crystal panel of semitransmissive type has both of the above-mentioned transmissive type and reflective type together. A liquid crystal panel of semitransmissive type utilizes a light source of the back light in a dark place to perform image display, and meanwhile to reflect solar light in the light to perform image display.

FIG. 1 shows a liquid crystal display device 100 of transmittance type in which the back light 10 is provided. However, the present invention is not limited to transmittance type alone, so that it may be a liquid crystal display device of the above-described reflection type or semi-transmittance type (though not particularly illustrated in the drawings).

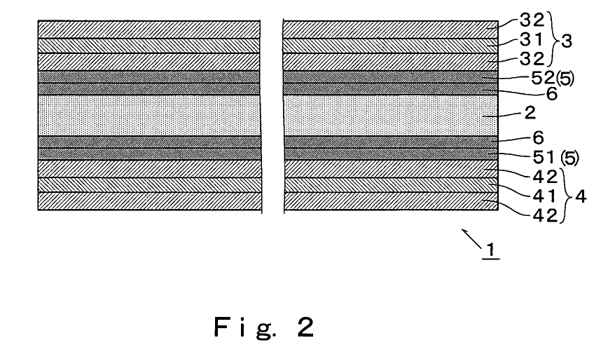

Next, FIG. 2 shows a construction example of the liquid crystal panel 1 of the present invention. This is one example of a liquid crystal panel of a TN mode.

In FIG. 2, the reference numeral 1 represents a liquid crystal panel; the reference numeral 2 represents a liquid crystal cell; and the reference numeral 3 represents a visible-side polarizing plate disposed on the visible side of the liquid crystal cell 2. This visible-side polarizing plate 3 includes a polarizer 31 (visible-side polarizer) and protective films 32 laminated on both sides thereof. The reference numeral 4 represents an antivisible-side polarizing plate disposed on the opposite side of the liquid crystal cell. This antivisible-side polarizing plate 4 includes a polarizer 41 (antivisible-side polarizer) and protective films 42 laminated on both sides thereof. The reference numeral 5 represents a polarization rotating layer that rotates linearly polarized light by approximately 45 degrees. The reference numeral 6 represents an optical compensating layer for compensation of a view angle.

The above-described polarization rotating layer 5 is disposed respectively between the visible-side polarizing plate 3 and the liquid crystal cell 2 and between the antivisible-side polarizing plate 4 and the liquid crystal cell 2. (Hereinafter, a polarization rotating layer disposed between the visible-side polarizing plate 3 and the liquid crystal cell 2 may be referred to as a “second polarization rotating layer”, and a polarization rotating layer disposed between the antivisible-side polarizing plate 4 and the liquid crystal cell 2 may be referred to as a “first polarization rotating layer” in some cases).

Also, the above-described optical compensating layer 6 is disposed respectively between the second polarization rotating layer 52 and the liquid crystal cell 2 and between the first polarization rotating layer 51 and the liquid crystal cell 2.

However, the liquid crystal panel 1 of the present invention is not limited to the construction shown in FIG. 2, so that various changes can be made. For example, the polarization rotating layers 5 (the first polarization rotating layer 51 and the second polarization rotating layer 52) may be disposed between the liquid crystal cell 2 and the optical compensating layer 6. Also, the optical compensating layer 6 may be disposed on either one of the visible side and the antivisible side. Hereinafter, each constituent member of the liquid crystal panel 1 will be described in a sequential manner.

### <About the Liquid Crystal Cell>

The liquid crystal cell is constructed in such a manner that the visible surface thereof (the visible surface refers to an image displaying surface) is formed to have a rectangular shape as viewed in a front view. Therefore, the lateral length of the visible surface of the liquid crystal panel is formed to be longer that the longitudinal length thereof. The ratio of the lateral and longitudinal lengths of the liquid crystal panel is not particularly limited; however, the ratio is typically such that the lateral length:longitudinal length=4:3, the lateral length:longitudinal length=16:9, or the like.

The size of the visible surface of the liquid crystal cell (namely, the visible surface of the liquid crystal panel) is not particularly limited, so that the present invention can be applied in a wide range from those having a comparatively small visible surface to those having a comparatively large visible surface. Among these, it is effective to apply the present invention to liquid crystal cells having a comparatively large screen. A specific dimension (length of the diagonal line of the visible surface) of such a liquid crystal cell (liquid crystal panel) is, for example, 20 inches or more, preferably 25 inches or more, and more preferably 30 inches or more.

The present invention can produce a liquid crystal panel of a TN mode having a comparatively large screen, and can prevent generation of the distortion of the liquid crystal panel.

A liquid crystal cell having a conventionally known structure can be used. For example, the liquid crystal cell includes a pair of liquid crystal cell substrates, a spacer interposed between the liquid crystal cell substrates, a liquid crystal layer formed between the pair of liquid crystal cell substrates and having a liquid crystal material injected therein, a color filter disposed on the inner surface of the liquid crystal cell substrate on the visible side, and an electrode element such as a TFT substrate for driving that is disposed on the inner surface of the other liquid crystal cell substrate.

The liquid crystal cell substrates are not particularly limited as long as they are excellent in transparency.

The liquid crystal cell substrates, for example, include transparent glass plates such as soda-lime glass, low-alkali borosilicate glass and no-alkali aluminoborosilicate glass, and transparent flexible plates having flexibility, for example, optical resin plates such as polycarbonate, polymethyl methacrylate, polyethylene terephthalate and epoxy resin.

The liquid crystal material to be injected into the liquid crystal layer is not particularly limited, so that suitable ones can be selected in accordance with the liquid crystal mode.

The liquid crystal cell of the present invention is preferably such that the longitudinal axis of the liquid crystal material is oriented approximately in the direction of 45 degrees relative to the longer side direction of the liquid crystal cell on the liquid crystal cell substrate side of the visible side, and is oriented in a direction perpendicular to the aforesaid orientation direction on the liquid crystal cell substrate side of the antivisible side.

As the liquid crystal cell, a normally white mode such as a TN (Twist Nematic) mode can be cited, for example.

Here, the normally white mode is a general name for the liquid crystal mode in which the visible surface of the liquid crystal panel becomes a white display (bright display) when voltage is not applied, and the visible surface of the liquid crystal panel becomes a black display (dark display) when voltage is applied.

In the liquid crystal cell of the TN mode, a pair of liquid crystal cell substrates are combined so that the rubbing direction (orientation processing direction) of the liquid crystal cell substrate on the visible side and the rubbing direction (orientation processing direction) of the liquid crystal cell substrate on the antivisible side will be perpendicular to each other, and a gap between the pair of liquid crystal cell substrates is filled with a liquid crystal material. Therefore, in the liquid crystal cell of the TN mode, the liquid crystal material is oriented in the orientation processing direction at the liquid crystal cell substrate on the antivisible side, and the liquid crystal material is twisted in the liquid crystal layer, whereby the liquid crystal material is oriented in the orientation processing direction of the liquid crystal cell substrate on the visible side.

In such a liquid crystal cell of the TN mode, for example, the orientation processing direction of the liquid crystal cell substrate on the visible side is formed to be approximately 135 degrees (or approximately 45 degrees) relative to the longer side direction of the liquid crystal cell, and the orientation processing direction of the liquid crystal cell substrate on the antivisible side is formed to be approximately in the perpendicular direction relative to the orientation processing direction of the visible side. Namely, the orientation direction of the liquid crystal material on the liquid crystal cell substrate side of the visible side will be approximately 135 degrees (or approximately 45 degrees) relative to the longer side direction of the liquid crystal cell, and the orientation direction of the liquid crystal material on the liquid crystal cell substrate side of the antivisible side will be approximately 45 degrees (or approximately 135 degrees) relative to the longer side direction of the liquid crystal cell.

Here, in the present specification, in specifying an angle, the angle refers to an angle formed in an anticlockwise direction as viewed from the visible side.

Also, in the present invention, unless specifically described otherwise, the term “approximately A degrees” such as approximately 45 degrees is used to include a meaning of A degrees±5 degrees, preferably A degrees±3 degrees. Further, in the present invention, the term “approximately parallel” is used to include a meaning of 0 degrees±5 degrees, preferably 0 degrees±3 degrees, and the term “approximately perpendicular” is used to include a meaning of 90 degrees±5 degrees, preferably 90 degrees±3 degrees. This is because a twist within ±5 degrees does not invite an obstacle in actually operating the liquid crystal panel of the present invention.

### <About the Polarizing Plate>

The visible-side polarizing plate includes a polarizer having a function of passing a specific linearly polarized light beam. The visible-side polarizing plate is preferably such that a protective film is laminated on one surface of the polarizer, and is especially preferably such that a protective film is laminated on both surfaces of the polarizer, as illustrated in FIG. 2. The polarizer is not particularly limited; however, a stretched film having a dichroic substance such as iodine adsorbed thereonto is preferable. In such a polarizer, the absorption axis is formed in a direction parallel to the main stretching direction of the film.

Similarly, the antivisible-side polarizing plate includes a polarizer having a function of passing a specific linearly polarized light beam. The antivisible-side polarizing plate is preferably such that a protective film is laminated on one surface of the polarizer, and is especially preferably such that a protective film is laminated on both surfaces of the polarizer, as illustrated in FIG. 2. The polarizer is not particularly limited; however, a stretched film having a dichroic substance such as iodine adsorbed thereonto is preferable. In such a polarizer, the absorption axis is formed in a direction parallel to the main stretching direction of the film.

The visible-side polarizing plate and the antivisible-side polarizing plate preferably include polarizers containing the same resin as a major component. Nevertheless, the polarizers may be made of different materials.

Further, because of exhibiting a similar expansion-shrinkage behavior in accordance with a change in the temperature or humidity at the time of use, the polarizer of the visible-side polarizing plate and the polarizer of the antivisible-side polarizing plate are preferably the same (at least having the same resin component and stretching ratio). In particular, the polarizer of the visible-side polarizing plate and the polarizer of the antivisible-side polarizing plate are preferably the same including the polarizers and the protective films.

In one embodiment of the present invention, the visible-side polarizing plate and the antivisible-side polarizing plate are disposed on the liquid crystal cell so that the absorption axis directions of the polarizers thereof will be approximately parallel to each other.

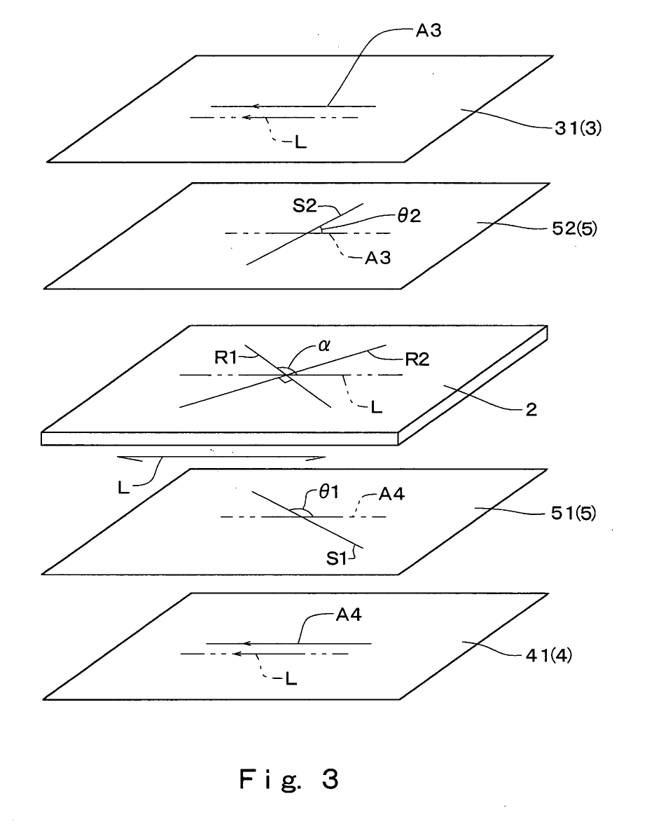

Specifically, as shown in FIG. 3, an absorption axis direction A3 of a visible-side polarizer 31 of the visible-side polarizing plate 3 and an absorption axis direction A4 of a antivisible-side polarizer 41 of the antivisible-side polarizing plate 4 are arranged to be approximately parallel to each other. Here, the absorption axis directions A3 and A4 of the two polarizers 31 and 41 are preferably arranged to be approximately parallel to the longer side direction L of the liquid crystal cell 2. Nevertheless, the absorption axis directions A3 and A4 of the two polarizers 31 and 41 may be arranged to be approximately perpendicular to the longer side direction L of the liquid crystal cell 2.

A liquid crystal panel in which the absorption axis direction of the visible-side polarizer and the absorption axis direction of the antivisible-side polarizer are arranged to be approximately parallel to each other is referred to as a “liquid crystal panel of parallel arrangement type”.

In such a “liquid crystal panel of parallel arrangement type”, when the liquid crystal cell thereof is in a TN mode, the liquid crystal cell substrate on the visible side is arranged so that the orientation processing direction R1 thereof will be at an angle of a (a is approximately 135 degrees or approximately 45 degrees) relative to the longer side direction L of the liquid crystal cell 2. On the other hand, the liquid crystal cell substrate on the antivisible side is arranged so that the orientation processing direction R2 thereof will be approximately perpendicular to the aforesaid orientation processing direction R1 of the visible side.

In another embodiment of the present invention, the visible-side polarizing plate is disposed on the liquid crystal cell so that the absorption axis direction of the polarizer thereof will be approximately perpendicular to or parallel to the longer side direction of the liquid crystal cell. On the other hand, the antivisible-side polarizing plate is disposed so that the absorption axis direction of the polarizer thereof will be approximately perpendicular to the absorption axis direction of the visible-side polarizing plate. Preferably, the visible-side polarizing plate is disposed on the liquid crystal cell so that the absorption axis direction thereof will be approximately parallel to the longer side direction of the liquid crystal cell.

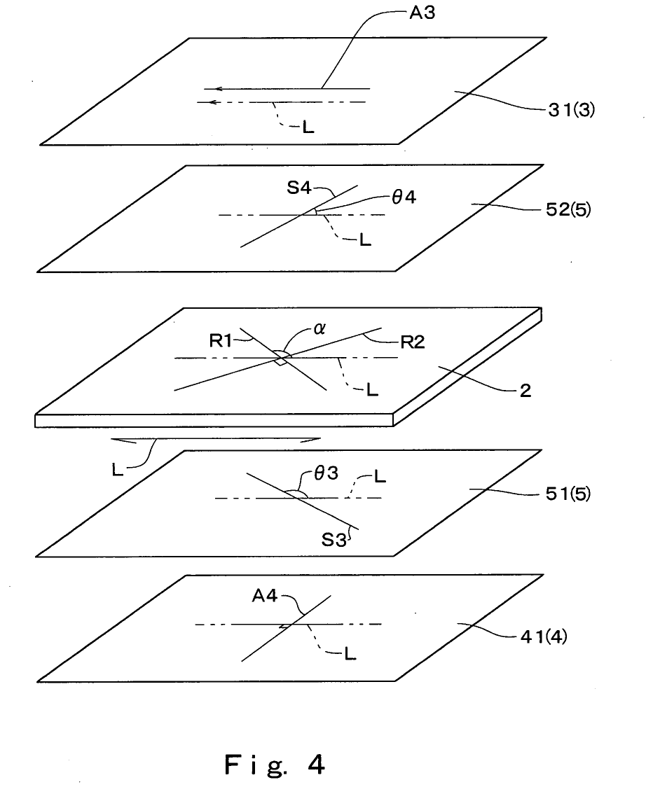

Specifically, as shown in FIG. 4, the absorption axis direction A3 of the visible-side polarizer 31 of the visible-side polarizing plate 3 is arranged to be approximately parallel to the longer side direction L of the liquid crystal cell 2. On the other hand, the absorption axis direction A4 of the antivisible-side polarizer 41 of the antivisible-side polarizing plate 4 is arranged to be approximately perpendicular to the longer side direction L of the liquid crystal cell 2. Here, although not illustrated in the drawings, the absorption axis direction A3 of the visible-side polarizer 31 of the visible-side polarizing plate 3 may be arranged to be approximately perpendicular to the longer side direction L of the liquid crystal cell 2, while the absorption axis direction A4 of the antivisible-side polarizer 41 of the antivisible-side polarizing plate 4 may be arranged to be approximately parallel to the longer side direction L of the liquid crystal cell 2.

A liquid crystal panel in which the absorption axis direction A3 of the visible-side polarizer 31 is arranged to be approximately perpendicular to or approximately parallel to the longer side direction L of the liquid crystal cell 2, and the absorption axis direction A3 of the visible-side polarizer 31 and the absorption axis direction A4 of the antivisible-side polarizer 41 are arranged to be approximately perpendicular to each other is referred to as a “liquid crystal panel of perpendicular arrangement type”.

In such a “liquid crystal panel of perpendicular arrangement type”, when the liquid crystal cell thereof is in a TN mode, the liquid crystal cell substrate on the visible side is arranged so that the orientation processing direction R1 thereof will be at an angle of α (α is approximately 135 degrees or approximately 45 degrees) relative to the longer side direction L of the liquid crystal cell 2. On the other hand, the liquid crystal cell substrate on the antivisible side is arranged so that the orientation processing direction R2 thereof will be approximately perpendicular to the aforesaid orientation processing direction R1 of the visible side.

The above-described polarizers are not particularly limited, so that various ones can be used. Examples of the polarizers include a film obtained by allowing a dichroic substance (iodine, a dichroic dye, or the like) to be adsorbed onto a hydrophilic polymer film (polyvinyl alcohol-based film (hereafter, polyvinyl alcohol will be denoted as “PVA”), partially formalated PVA-based film, ethylene-vinyl acetate copolymer-based partially saponified film, or the like) and subjected to uniaxial stretching; a polyene-based oriented film such as dehydrated product of PVA or dehydrochlorinated product of polyvinyl chloride; or the like. Among these, the polarizers are preferably a stretched film obtained by allowing a dichroic substance such as iodine to be adsorbed onto a hydrophilic polymer film (preferably a PVA-based film). The thickness of the polarizers is not particularly limited; however, it is typically about 5 to 80 μm.

A polarizer made of a film obtained by allowing iodine to be adsorbed (dyeing) onto a PVA-based film and subjected to stretching can be produced by a conventionally known method. For example, by immersing a PVA-based film into an aqueous solution of iodine, the film is dyed with iodine. A stretched film obtained by uniaxial stretching of this film to a length 3 times to 7 times as large as the original length is used as the polarizers. In producing the polarizers, the PVA-based film may be immersed into an aqueous solution of potassium iodide optionally containing boric acid, zinc sulfate, zinc chloride, or the like. Further, in accordance with the needs, the PVA-based film may be immersed into water for cleaning with water before the dyeing. By cleaning the PVA-based film with water, the stain or the antiblocking agent on the PVA-based film surface can be removed. Further, by cleaning the PVA-based film with water, the PVA-based film will swell, thereby exhibiting an effect of preventing non-uniformity in dyeing such as unevenness in dyeing. Regarding the above-described stretching, (a) the stretching process may be carried out after dyeing with iodine, or (b) the stretching process may be carried out while dyeing, or (c) the dyeing with iodine may be carried out after the stretching process, or (d) the stretching process may be carried out in an aqueous solution of boric acid, potassium iodide or the like, or in a water bath.

The protective film provided in the polarizer is preferably a film being excellent in transparency, mechanical strength, thermal stability, shielding property against humidity, isotropy, and the like. Examples of the protective film include films of a polyester-based polymer such as polyethylene terephthalate or polyethylene naphthalate; cellulose-based polymer such as diacetylcellulose or triacetylcellulose; acrylic-based polymer such as polymethyl methacrylate; styrene-based polymer such as polystyrene or acrylonitrile-styrene copolymer (AS resin); polycarbonate-based polymer, and the like. Also, the examples include polymer films of polyolefin-based polymer such as polyethylene, polypropylene, polyolefin having a cyclo-based or norbornene structure, or ethylene-propylene copolymer; vinyl chloride-based polymer; amide-based polymer such as nylon or aromatic polyamide; imide-based polymer; sulfone-based polymer; polyethersulfone-based polymer; polyetheretherketone-based polymer; polyphenylene sulfide-based polymer; vinyl alcohol-based polymer; vinylidene chloride-based polymer; vinyl butyral-based polymer; allylate-based polymer; polyoxymethylene-based polymer; epoxy-based polymer; the blended product of these polymers described above; and the like. The protective film can also be formed with a cured layer of thermosetting-type or ultraviolet-setting type resin such as acrylic-based, urethane-based, acrylurethane-based, epoxy-based, or silicone-based.

Further, as the protective film, one can use, for example, a polymer film disclosed in Japanese Patent Application Laid-Open (JP-A) No. 2001-343529. The polymer film is a film including a resin composition containing, for example, (A) a thermoplastic resin having a substituted and/or non-substituted imide group in a side chain and (B) a thermoplastic resin having a substituted and/or non-substituted phenyl group and nitrile group in a side chain. A specific example of this film is a film of a resin composition containing alternate copolymer of isobutylene and N-methylmaleimide and acrylonitrile-styrene copolymer. As the film, those made of a mixed extruded product of the resin compositions or the like can be used.

The thickness of the protective film can be suitably determined. Typically, in view of the operability such as strength and handling property and the thin film property, the thickness of the protective film is about 1 to 500 μm, and preferably 5 to 200 μm.

Also, the protective film is preferably colored to the least extent. Also, a protective film having a retardation value (Rth) of −90 nm to +75 nm in the thickness direction of the film for the visible light at 23° C. is preferably used. By using a film having a retardation value (Rth) of −90 nm to +75 nm in the thickness direction, the coloring (optical coloring) of the polarizing plate due to the protective film can be almost completely eliminated. The retardation value (Rth) in the thickness direction is more preferably −80 nm to +60 nm, and most preferably −70 nm to +45 nm.

Here, the retardation value (Rth) in the thickness direction can be determined as Rth=(nx−nz)×d (where nx is the refractive index of the slow axis direction within the protective film surface; nz is the refractive index in the thickness direction of the protective film; and d is the protective film thickness [nm]).

As the protective film, a cellulose-based polymer film such as triacetylcellulose is preferable in view of the polarization property and the durability. In particular, it is preferable to use triacetylcellulose as the protective film. Here, in the case of disposing a protective film on both sides of the polarizer, it is preferable to use polymer films made of the same material as the two protective films; however, different polymer films may be used as well.

The polarizer and the protective film are bonded typically through the intermediary of a water-based pressure sensitive adhesive or the like. Examples of the water-based pressure sensitive adhesive include isocyanate-based pressure sensitive adhesives, PVA-based pressure sensitive adhesives, gelatin-based pressure sensitive adhesives, vinyl-based latex-based pressure sensitive adhesives, water-based polyurethane pressure sensitive adhesives, water-based polyester pressure sensitive adhesives, and the like.

On the surface of the aforesaid protective film on which the polarizer is not bonded, a hard coat layer may be disposed, or various processes such as antireflection process, antisticking process, or process intended for the purpose of diffusion or antiglaring may be performed.

The hard coat layer is disposed for the purpose of preventing damages to the polarizing plate surface, or the like. The hard coat layer can be formed, for example, by adding a cured coating film being excellent in hardness or sliding property onto the surface of the protective film. Examples of the aforesaid cured coating film include cured films of ultraviolet-setting type resin such as acrylic-based or silicone-based resin, and the like. The antireflection process is carried out for the purpose of preventing reflection of external light on the polarizing plate surface. The antireflection process can be formed by adding an antireflection film similar to conventional ones onto the protective film. Also, the antisticking process is carried out for the purpose of preventing close adhesion to adjacent layers of other members.

Also, the antiglaring process is carried out for the purpose of preventing the visibility hindrance of the light transmitted through the polarizing plate by reflection of external light on the surface of the polarizing plate, or the like. As the antiglaring process, one can cite, for example, means for surface-roughening of the protective film surface by the sandblast method or the emboss-processing method, or means for forming a protective film by blending transparent fine particles into the transparent resin, or the like. With use of these means, a fine bumpy structure can be formed on the surface of the protective film. As the aforesaid transparent fine particles, one can cite, for example, inorganic fine particles (optionally having an electric conductivity in some cases) made of silica, alumina, titania, zirconia, tin oxide, indium oxide, cadmium oxide, antimony oxide, or the like having an average particle diameter of 0.5 μm to 50 μm, organic fine particles (including beads) made of a cross-linked or non-cross-linked polymer, or the like. In this case, the amount of use of the transparent fine particles is typically about 2 to 50 parts by weight, preferably 5 to 25 parts by weight, with respect to 100 parts by weight of the transparent resin. The antiglaring process may also serve as a diffusing layer (viewing angle enlarging function or the like).

Here, the antireflection layer, the antisticking layer, the diffusing layer, the antiglaring layer, and the like described above may be disposed on the protective film itself, or these may be applied on another optical film and the optical film may be laminated on the protective film.

### <Polarization Rotating Layer>

The polarization rotating layer is an optical layer having a function of rotating the polarization plane of the linearly polarized light that has passed through the polarizing plate by about 45 degrees with the line perpendicular to the plane of the polarization rotating layer serving as a central axis. Namely, the polarization rotating layer is an optical layer having a function of rotating the linearly polarized light that is incident into the polarization rotating layer so that the light will be in a state of being shifted by about 45 degrees at the time of outgoing. The polarization rotating layer of the present invention is not particularly limited as long as it has this function, so that various ones can be used.

This polarization rotating layer is disposed respectively between the antivisible-side polarizing plate and the liquid crystal cell and between the visible-side polarizing plate and the liquid crystal cell.

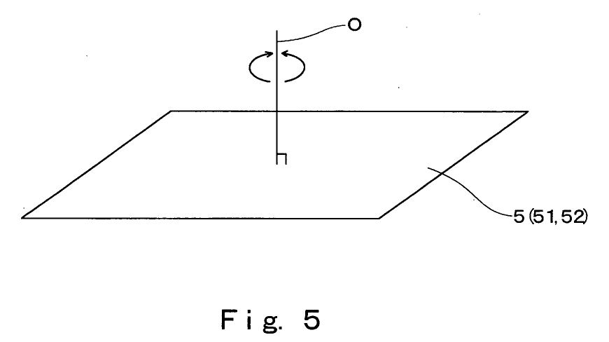

Here, the term “rotation of the polarization plane of linearly polarized light by about 45 degrees” is used to mean that, as shown in FIG. 5, the polarization plane of the linearly polarized light is rotated in any of the clockwise direction and anticlockwise direction by about 45 degrees (including 360 degrees×integers+45 degrees; however, the aforesaid integers include 0) with the line perpendicular to the plane of the polarization rotating layer 5 serving as a central axis O.

The first polarization rotating layer and the second polarization rotating layer may be formed with a single layer, or may be formed with plural layers of two or more layers respectively.

Typically, each polarization rotating layer is bonded onto a constituent member of the liquid crystal panel such as the polarizing plate with use of a suitable pressure sensitive adhesive or adhesive.

As the polarization rotating layer that rotates the linearly polarized light by approximately 45 degrees, one can cite, for example, (a) a ½ wavelength plate, (b) a layer having a liquid crystal material subjected to cholesteric orientation, and the like layers.

The (a) ½ wavelength plate used as the polarization rotating layer has a function of generating a retardation of ½ wavelength in the incident light, and a conventionally known retardation plate (a ½ wavelength plate is one kind of the retardation plate) can be used.

The aforesaid ½ wavelength plate preferably has an in-plane retardation value (And) of 120 to 360 nm, more preferably 160 to 320 nm, most preferably 200 to 280 nm, at a temperature of 23° C. and for the wavelength of 550 nm, for example.

Also, preferably, the ½ wavelength plate has a refractive index property of any one of nx₁>ny₁>nz₁, nx₁>ny₁≅nz₁, and nx₁>nz₁>ny₁.

Here, nx₁ represents a refractive index in an X-axis direction in a plane of the ½ wavelength plate, ny₁ represents a refractive index in a Y-axis direction in the plane, and nz₁ represents a refractive index in a direction perpendicular to said X-axis direction and Y-axis direction. The X-axis direction is an axis direction in which the refractive index attains a maximum value in the plane, and the Y-axis direction is a direction perpendicular to an X-axis in the plane.

Also, the in-plane retardation value (Δnd) of the ½ wavelength plate can be determined as Δnd=(nx₁−ny₁)×d₁, where nx₁ and ny₁ have the same meaning as the above-mentioned, and d₁ indicates the thickness [nm] of the ½ wavelength plate.

The material of the ½ wavelength plate is not particularly limited, so that a conventionally known one can be used.

For example, the ½ wavelength plate can be formed with polyolefin (polyethylene, polypropylene, polynorbornene, or the like), amorphous polyolefin, polyimide, polyamideimide, polyamide, polyetherimide, polyetheretherketone, polyetherketone, polyketone sulfide, polyether sulfone, polysulfone, polyphenylene sulfide, polyphenylene oxide, polyethylene terephthalate, polyebutylene terephthalate, polyethylene naphthalate, polyacetal, polycarbonate, polyarylate, polymethylmethacrylate, polymethacrylate, polyacrylate, polystyrene, cellulose-based polymer (triacetylcellose or the like), PVA, epoxy resin, phenol resin, ester resin, acrylate resin, vinyl chloride resin, vinylidene chloride resin, or blended polymer of these.

The ½ wavelength plate can be obtained by forming these resin compositions into a film and performing uniaxial stretching, biaxial stretching, or the like. Also, as the ½ wavelength plate, one can use an oriented film in which a liquid crystalline polymer or a liquid crystalline monomer is oriented.

The aforesaid ½ wavelength plate may be made of a single layer or plural layers of two or more layers.

In the case of using a monolayer ½ wavelength plate as the polarization rotating layer 5 in a “liquid crystal panel of parallel arrangement type”, the first polarization rotating layer 51 and the second polarization rotating layer 52 may be arranged respectively as shown in FIG. 3, for example.

Specifically, for example, the first polarization rotating layer 51 is arranged so that the angle θ1 formed by the slow axis direction S1 thereof and the absorption axis direction A4 of the polarizer 41 of the antivisible-side polarizing plate 4 will be about 157.5 degrees. This term “about 157.5 degrees” is used to include a meaning of 157.5 degrees±2.5 degrees (preferably 157.5 degrees±1.5 degrees). Also, the slow axis direction refers to an axis direction in which the refractive index attains a maximum value within the plane of the polarization rotating layer (½ wavelength plate).

By laminating the monolayer ½ wavelength plate in such an arrangement, linearly polarized light that has passed through the ½ wavelength plate will be linearly polarized light whose polarization plane is rotated by about 45 degrees.

On the other hand, the second polarization rotating layer 52 is arranged so that the angle θ2 formed by the slow axis direction S2 thereof and the absorption axis direction A3 of the polarizer 31 of the visible-side polarizing plate 3 will be about 22.5 degrees. Here, this term “about 22.5 degrees” is used to include a meaning of 22.5 degrees±2.5 degrees (preferably 22.5 degrees±1.5 degrees).

By laminating the monolayer ½ wavelength plate in such an arrangement, linearly polarized light that has passed through the ½ wavelength plate will be linearly polarized light whose polarization plane is rotated by about 45 degrees.

Therefore, the linearly polarized light that has passed through the antivisible-side polarizing plate will be linearly polarized light whose polarization plane is rotated by about 90 degrees by passing through the first polarization rotating layer 51 and the second polarization rotating layer 52.

However, in FIG. 3, though the above-described angles θ1 and θ2 illustrate a case in which the slow axis of the ½ wavelength plate is tilted in an anticlockwise direction as viewed from the visible surface side, the slow axis of the ½ wavelength plate may be tilted in a clockwise direction as well.

In the case of using a monolayer ½ wavelength plate as the polarization rotating layer 5 in a “liquid crystal panel of perpendicular arrangement type”, the first polarization rotating layer 51 and the second polarization rotating layer 52 may be arranged respectively as shown in FIG. 4, for example.

Specifically, for example, the first polarization rotating layer 51 is arranged so that the angle θ3 formed by the slow axis direction S3 thereof and the longer side direction L of the liquid crystal cell 2 will be about 112.5 degrees. This term “about 112.5 degrees” is used to include a meaning of 112.5 degrees±2.5 degrees (preferably 112.5 degrees±1.5 degrees). The slow axis direction refers to an axis direction in which the refractive index attains a maximum value within the plane of the polarization rotating layer (½ wavelength plate).

By laminating the ½ wavelength plate in such an arrangement, linearly polarized light that has passed through the ½ wavelength plate will be linearly polarized light whose polarization plane is rotated by about 45 degrees.

On the other hand, the second polarization rotating layer 52 is arranged so that the angle θ4 formed by the slow axis direction S4 thereof and the longer side direction L of the liquid crystal cell 2 will be about 22.5 degrees. Here, this term “about 22.5 degrees” is used to include a meaning of 22.5 degrees±2.5 degrees (preferably 22.5 degrees±1.5 degrees).

By laminating the ½ wavelength plate in such an arrangement, linearly polarized light that has passed through the ½ wavelength plate will be linearly polarized light whose polarization plane is rotated by about 45 degrees.

Therefore, the linearly polarized light that has passed through the antivisible-side polarizing plate will be linearly polarized light whose polarization plane is rotated by about 90 degrees by passing through the first polarization rotating layer 51 and the second polarization rotating layer 52.

However, in FIG. 4, though the above-described angles θ3 and θ4 show a case of tilting in an anticlockwise direction as viewed from the visible surface side, the tilting may be carried out in a clockwise direction as well.

Next, the aforesaid (b) polarization rotating layer having a liquid crystal material subjected to cholesteric orientation has a function of rotating the polarization plane of the linearly polarized light because the liquid crystal material assumes a spiral structure.

Such a polarization rotating layer can be exemplified by those obtained by forming a compound containing a nematic liquid crystal material (liquid crystal material in which the liquid crystal phase is a nematic phase) and a chiral agent into a film form.

As the liquid crystal material, it is preferable to use polymerizable nematic liquid crystal monomers represented by the following general formula (I), for example. These liquid crystal monomers may be used either as one kind or as two or more kinds in combination.

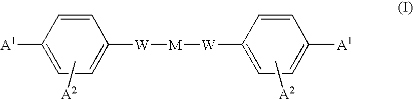

In the general formula (I), A¹ and A² each represent a polymerizable group, and may be the same or different. Also, one of A¹ and A² may be hydrogen. The groups W each represent a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR; and R in the aforesaid W represents H or C₁ to C₄ alkyl; and M represents a mesogenic group.

In the general formula (I), two groups W may be the same or different; however, the two are preferably the same. Also, the two groups A² are each preferably configured in the ortho-position relative to A¹.

Further, A¹ and A² in the general formula (I) are preferably each independently represented by the following general formula (II).

Z-W-(Sp)n General formula (II)

In the general formula (II), Z represents a cross-linking group; W is the same as those in the above general formula (I); Sp represents a spacer composed of straight-chain or branched-chain alkyl group having 1 to 30 carbon atoms; and n represents 0 or 1. The carbon chain in the above Sp may be intervened with oxygen in an ether functional group, sulfur in a thioether functional group, a non-adjacent imino group, an alkylimino group of C₁ to C₄, or the like.

The groups A¹ and A² in the above general formula (I) are preferably the same group. Also, Z in the general formula (II) is preferably any one of the atomic groups represented by the following formula (III). In the formula (III), R may be, for example, a group such as methyl, ethyl, n-propyl, i-propyl, n-butyl, i-butyl, t-butyl, or the like.

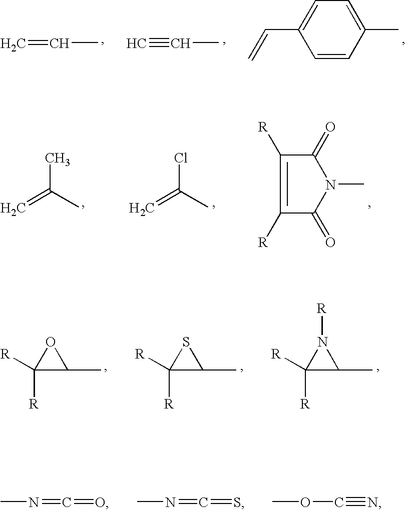

Also, in the aforesaid general formula (II), Sp is preferably any one of the atomic groups represented by the following general formula (IV). In the following general formula (IV), q is preferably 1 to 3; and p is preferably 1 to 12.

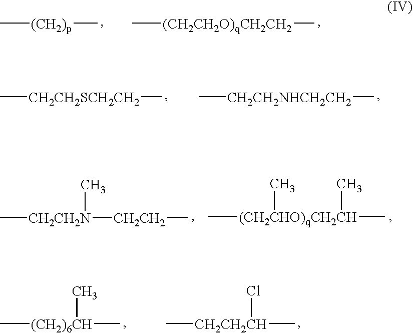

Also, in the above general formula (I), M is preferably a group represented by the following general formula (V). In the general formula (V), W is the same as W in the above general formula (I). The group Q represents, for example, a substituted or nonsubstituted alkylene or aromatic hydrocarbon atomic group, and may be substituted or nonsubstituted, straight-chain or branched-chain, C₁ to C₁₂ alkylene, or the like.

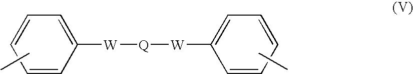

In the case where the above Q is an aromatic hydrocarbon atomic group, Q is preferably an atomic group such as represented by the following general formula (VI) or a substitution analog thereof, for example.

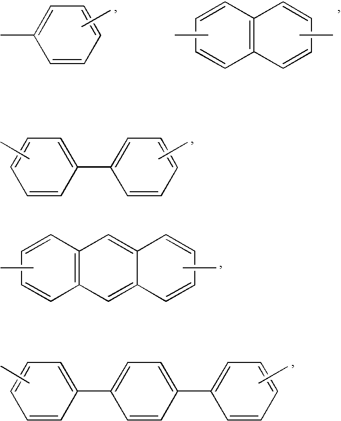

The substitution analog of an aromatic hydrocarbon atomic group represented by the above general formula (VI) may have 1 to 4 substituent groups per one aromatic ring, and may have 1 or 2 substituent groups per one aromatic ring or group. These substituent groups may each be the same or different. Examples of these substituent groups include C₁ to C₄ alkyl, nitro, halogen such as F, Cl, Br and I, phenyl, C₁ to C4 alkoxy, and the like.

Specific examples of the liquid crystal monomers described above in detail are, for example, monomers represented by the following structural formulas (2) to (17).

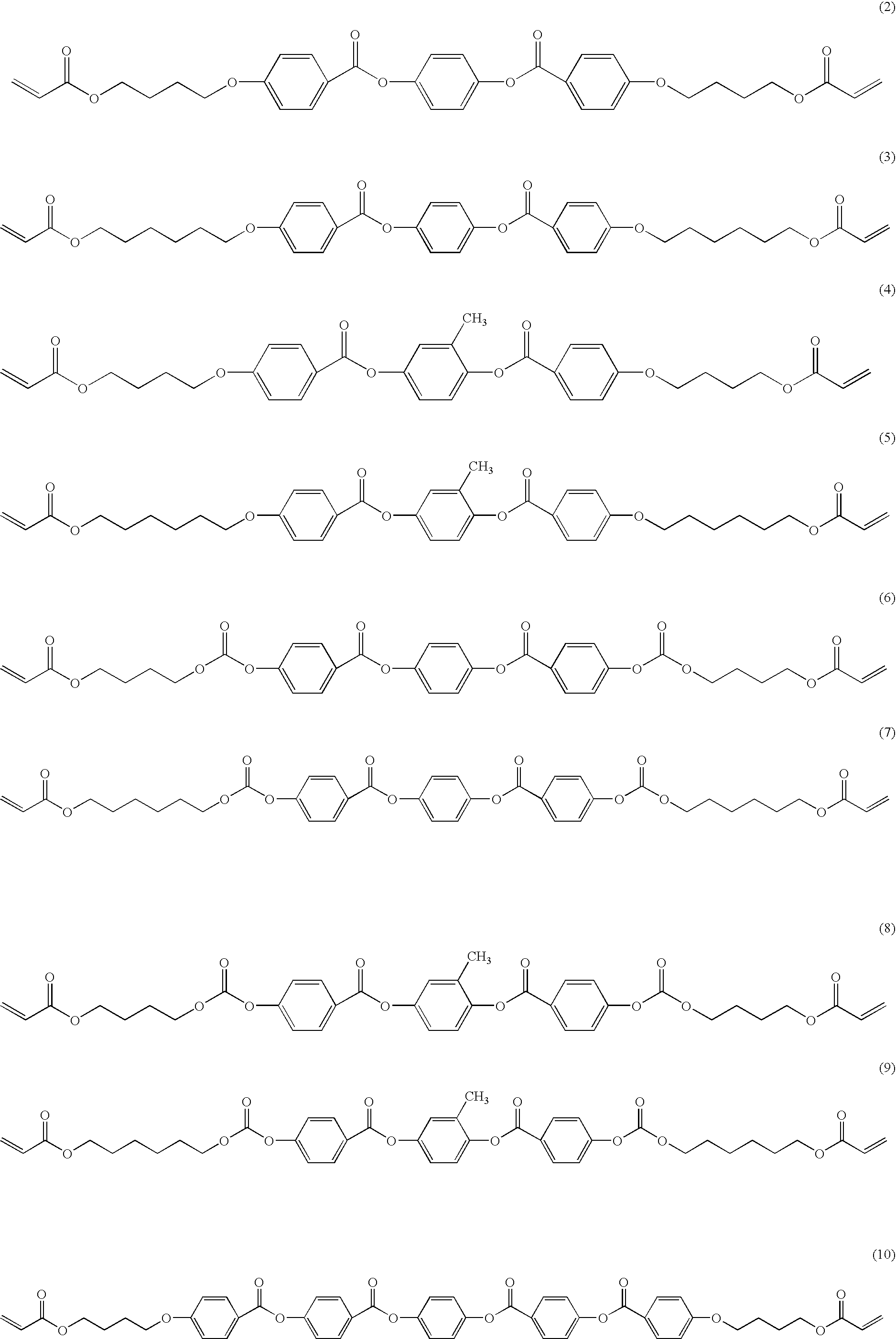

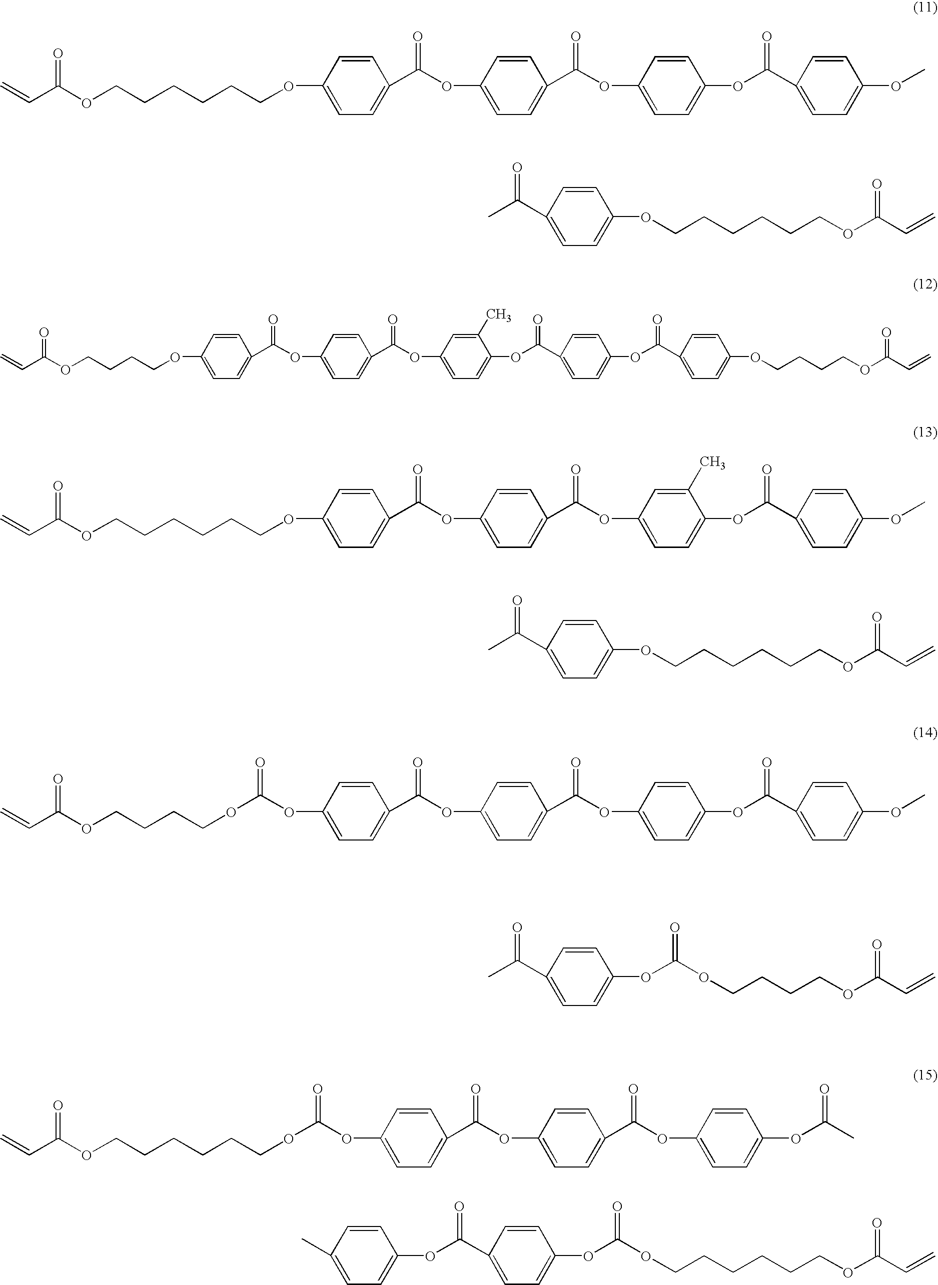

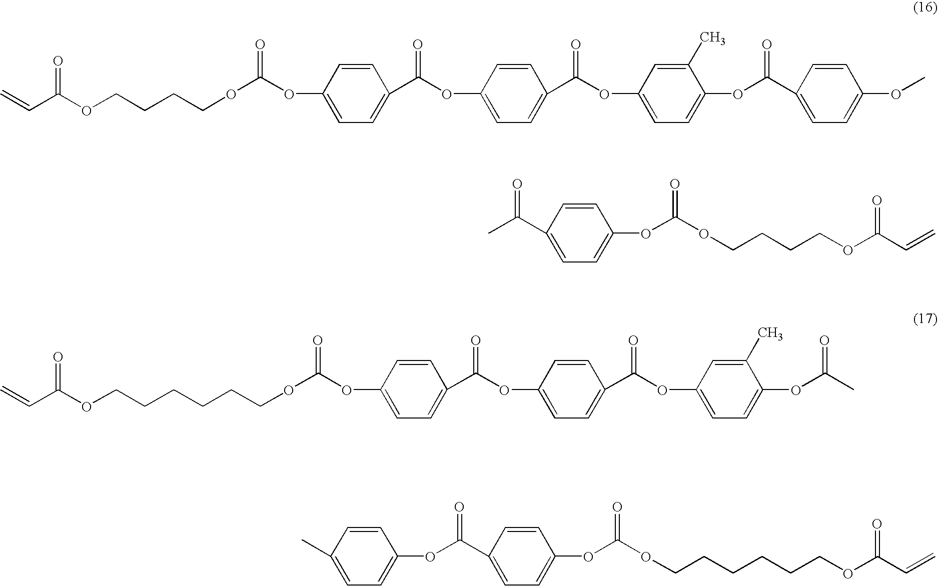

The temperature range in which the above-described liquid crystal monomer exhibits liquid crystallinity may differ depending on the kind thereof, however, the temperature range is preferably, for example, a range from 40 to 120° C., more preferably a range from 50 to 100° C., and most preferably a range from 60 to 90° C.

Also, the chiral agent is not particularly limited as long as it is, for example, one capable of imparting a twist to the liquid crystal monomer to orient the liquid crystal monomer so as to form a cholesteric structure. As the chiral agent, it is preferable to use a polymerizable chiral agent. These chiral agents may be used either as one kind or as two or more kinds in combination.

As a specific example of the chiral agent, one can suitably use those disclosed in Japanese Patent Application Laid-Open (JP-A) No. 2003-287623, [0049] to [0056].

The polymerizing agent and the cross-linking agent for polymerizing the liquid crystal monomer are not particularly limited; however, one such as the following can be used. As the aforesaid polymerizing agent, one can use, for example, benzoyl peroxide (BPO), azobisisobutyronitrile (AIBN), or the like. As the aforesaid cross-linking agent, one can use, for example, an isocyanate-based cross-linking agent, an epoxy-based cross-linking agent, a metal chelate cross-linking agent, or the like. These may be used either as one kind or as two or more kinds in combination.

Application liquid is prepared by dissolving and dispersing a liquid crystal monomer, a chiral agent, a polymerizing agent, and the like into a suitable solvent, and this is applied onto a suitable oriented substrate to form a layer.

Here, a method of forming a layer including the aforesaid liquid crystal monomer and chiral agent is described in detail in Japanese Patent Application Laid-Open (JP-A) No. 2003-287623, [0057] to [0072] and the like, so that one may carry out the process in accordance therewith.

The ratio of blending the aforesaid nematic liquid crystal material and chiral agent is not limited as long as the layer (polarization rotating layer) obtained from these assumes a cholesteric structure capable of rotating linearly polarized light by about 90 degrees. Specifically, it is preferable that 0.01 to 0.2 parts by weight of the chiral agent is contained with respect to 100 parts by weight of the nematic liquid crystal material; and further it is more preferable that 0.02 to 0.15 parts by weight of the chiral agent is contained; and it is most preferable that 0.03 to 0.1 parts by weight of the chiral agent is contained.

### <About the Optical Compensating Layer>

The optical compensating layer is constructed with a birefringent layer exhibiting a predetermined retardation. The optical compensating layer is also referred to as a retardation plate.

The optical compensating layer is provided in a liquid crystal panel for the purpose of improving the view angle characteristics, and a conventionally known one can be suitably selected for use.

As the optical compensating layer, one can use an optical compensating layer in which the refractive index (nz₂) in the thickness direction is smaller than the refractive index (nx₂, ny₂) in the plane (nx₂≅ny₂>nz₂), an optical compensating layer in which the refractive index (nz₂) in the thickness direction is larger than the refractive index (nx₂, ny₂) in the plane (nx₂≅ny₂<nz₂), or other optically uniaxial optical compensating layers (nx₂>ny₂≅nz₂). Also, one can use optically biaxial optical compensating layers (nx₂>ny₂>nz₂, nx₂>nz₂>ny₂, and the like) as well.

Here, nx₂ represents a refractive index in an X-axis direction in a plane of the optical compensating layer, ny₂ represents a refractive index in a Y-axis direction in the plane, and nz₂ represents a refractive index in a direction perpendicular to said X-axis direction and Y-axis direction. The X-axis direction is an axis direction in which the refractive index attains a maximum value in the plane, and the Y-axis direction is a direction perpendicular to an X-axis in the plane.

In the present invention, in the case of a liquid crystal panel in the TN mode, a slant orientation layer is preferably used as the optical compensating layer.

The slant orientation layer is formed of a material exhibiting an optically negative uniaxial property, and the aforesaid material is in slant orientation in the thickness direction. A material exhibiting an optically negative uniaxial property refers to a material having a refractive index distribution such that the refractive index of the main axis in one direction is smaller than the refractive indices in the other two directions. A material like this has, for example, a refractive index distribution such as nx₂≈ny₂>nz₂.

As a specific example of a material exhibiting an optically negative uniaxial property, one can cite a polyimide-based material or a liquid crystal based material such as a discotic liquid crystal compound. Further, as the slant orientation layer, one can use a film obtained by fixing in a slant orientation state a material that exhibits a negative uniaxial property. The material that exhibits a negative uniaxial property is obtained by mixing and reacting the aforesaid polyimide-based material or liquid crystal based material, and other polymers or oligomers. Among these, a liquid crystal based material is preferable, and a discotic liquid crystal compound is especially preferable. In the case of using a discotic liquid crystal compound, the slant orientation state thereof can be controlled by adjusting the kind and the molecular structure of the discotic liquid crystal compound, the kind of the orientation film, the additives (for example, plasticizers, binders, surfactants), and the like.

The aforesaid discotic liquid crystal compound generally refers to a liquid crystalline compound having a disk-shaped molecular structure with a cyclic nucleus at the center and substituents radially substituted as the side chains of the nucleus. The aforesaid cyclic nucleus is, for example, benzene, 1,3,5-triazine, carixarene, or the like. The aforesaid substituents are, for example, a straight-chain alkyl group, a straight-chain alkoxy group, a substituted benzoyloxy group, or the like. As representative examples of the discotic liquid crystal, one can cite (1) benzene derivatives, triphenylene derivatives, toluxel derivatives, and phthalocyanine derivatives disclosed in Research Reports by C. Destrade and others, Mol. Cryst. Liq. Cryst., Vol. 71, p. 111 (1981); (2) cyclohexane derivatives disclosed in Research Reports by B. Kohne and others, Angew, Chem., Vol. 96, p. 70 (1984); (3) azacrown-based and phenylacetylene-based macrocycles disclosed in Research Reports by J. M. Lehn and others, J. Chem, Soc. Chem. Commun., p. 1794 (1985) or in Research Reports by J. Zhang and others, J. Am. Chem. Soc., Vol. 116, p. 2655 (1994); and others.

The term “slant orientation” used in the present invention refers to a state in which the molecules of a material exhibiting an optically negative uniaxial property (for example, a discotic liquid crystal compound) are arranged to be slant relative to the plane. The slant orientation state may be such that the slant angle of the molecules changes in accordance with the thickness direction or such that the slant angle of the molecules is constant without a change in the thickness direction (tilt orientation).

The average optical axis of the material exhibiting an optically negative uniaxial property is tilted preferably at an angle of 5 to 50 degrees, more preferably 10 degrees to 30 degrees, and most preferably 15 degrees to 25 degrees, relative to the normal line direction of the slant orientation layer. By controlling the slant angle to be 5 degrees or more, the effect of enlarging the view angle is large in the case of mounting on a liquid crystal display device. By controlling the slant angle to be 50 degrees or less, the view angle characteristics will be good in any of the four directions of up and down and right and left (namely, one can restrain the field-of-view angle characteristics becoming good or bad depending on the viewing direction).

The in-plane retardation value of the slant orientation layer is preferably 0 to 200 nm, more preferably 1 to 150 nm. Further, the retardation value in the thickness direction of the slant orientation layer is preferably 10 to 400 nm, more preferably 50 to 300 nm.

The thickness of the slant orientation layer is not particularly limited; however, it is preferably 1 to 10 μm, for example, and more preferably 2 to 7 μm.

In the “liquid crystal panel of parallel arrangement type”, the visible-side polarizer and the antivisible-side polarizer are disposed on the liquid crystal cell so that the absorption axis direction of the visible-side polarizer and the absorption axis direction of the antivisible-side polarizer will be approximately parallel to each other. For this reason, the visible-side polarizer and the antivisible-side polarizer can shrink or expand in the same direction in accordance with a change in the temperature or humidity at the time of use of the panel. Therefore, the stress applied to the liquid crystal cell by expansion-shrinkage of the two polarizers will be applied in the same direction on both surface sides of the liquid crystal cell, whereby the distortion of the liquid crystal panel can be prevented.

In particular, a liquid crystal panel having a comparatively large-scale displaying surface also has a large area of the polarizers, so that the problem of distortion caused by expansion-shrinkage of the polarizers is liable to occur; however, the above-described liquid crystal panel can effectively prevent the distortion of the liquid crystal panel even with a comparatively large-scale displaying surface.

Also, in the above-described liquid crystal panel, the absorption axis directions of the visible-side polarizer and the antivisible-side polarizer disposed respectively on the two surface sides of the liquid crystal cell are arranged to be approximately parallel to each other, so that the two polarizers will not be in a crossed-nicols state. Regarding this point, since two polarization rotating layers (first polarization rotating layer and second polarization rotating layer) that rotate linearly polarized light by approximately 45 degrees in the same direction are disposed between the two polarizers, there will be no obstacle in the image displaying function of the liquid crystal panel.

Specifically, for example, by taking the liquid crystal panel of the present invention equipped with a back light unit as an example, the linearly polarized light that has passed through the antivisible-side polarizer will have its polarization plane rotated by approximately 45 degrees in one direction (for example, in the anticlockwise direction) by entering the first polarization rotating layer. This linearly polarized light will be rotated by 90 degrees by or pass as it is through the liquid crystal cell of the TN mode or the like, and enters the second polarization rotating layer. By entering this second polarization rotating layer, the linearly polarized light will be further rotated by approximately 45 degrees in one direction (for example, in the anticlockwise direction). Thus, the linearly polarized light that has passed through the antivisible-side polarizer will be rotated by a sum of about 90 degrees via the first polarization rotating layer and the second polarization rotating layer before entering the visible-side polarizer, so that the linearly polarized light will be in a crossed-nicols state between the antivisible-side polarizer and the visible-side polarizer. Therefore, the liquid crystal panel can display images well by a conventional method of driving a liquid crystal cell of the TN mode or the like.

In the “liquid crystal panel of perpendicular arrangement type”, the absorption axis direction of the visible-side polarizer is disposed approximately in the perpendicular direction (or approximately in the parallel direction) relative to the longer side direction of the liquid crystal cell, and the absorption axis direction of the antivisible-side polarizer is disposed approximately in a direction perpendicular to the absorption axis direction of the visible-side polarizer. For this reason, in accordance with a change in the temperature or humidity at the time of use of the panel, the visible-side polarizer can shrink or expand approximately in the perpendicular direction (or approximately in the parallel direction) relative to the longer side direction of the liquid crystal cell, whereas the antivisible-side polarizer can shrink or expand approximately in the parallel direction (or approximately in the perpendicular direction) relative to the longer side direction of the liquid crystal cell. For this reason, the “liquid crystal panel of perpendicular arrangement type” does not generate a deformation stress in different diagonal directions on the front and back surfaces of the liquid crystal cell as in a conventional liquid crystal panel. Therefore, as compared with the above-described conventional liquid crystal panel, the “liquid crystal panel of perpendicular arrangement type” of the present invention hardly generates distortion in the peripheral part.

Here, in the above-described “liquid crystal panel of perpendicular arrangement type” also, two polarization rotating layers (first polarization rotating layer and second polarization rotating layer) that rotate linearly polarized light by approximately 45 degrees are provided. Therefore, the linearly polarized light that passes through the antivisible-side polarizer can be suitably switched between passage and non-passage to the visible-side polarizer by driving of the liquid crystal cell of the TN mode or the like, so that the images can be displayed by a principle similar to that of the conventional one.

Further, the liquid crystal panel of the present invention can overcome the limit in increasing the visible surface size accompanying the restrictions in production.

Specifically, the polarizer containing a stretched film or the polarizer made of a stretched film is produced by stretching a hydrophilic polymer film on which a dichroic substance such as iodine is adsorbed, as described above.

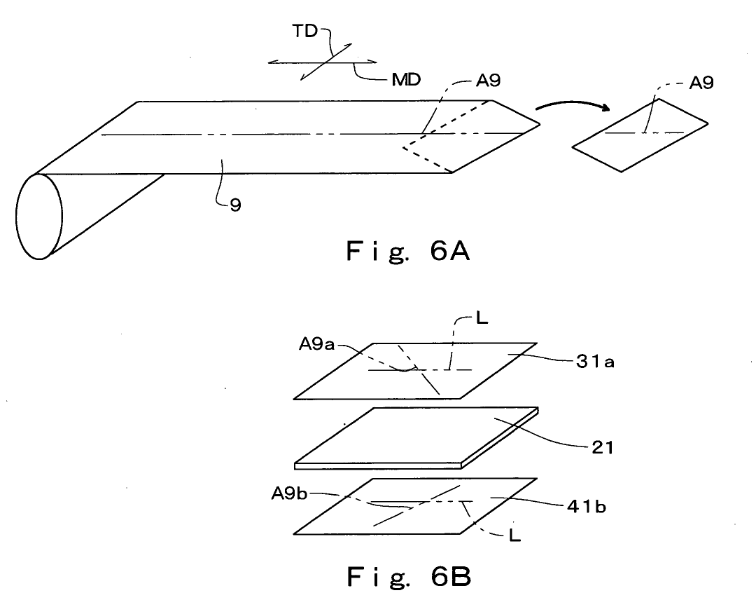

In producing this mechanically, a source film is drawn out from an extremely long film source roll having a predetermined width, and a dichroic substance is adsorbed, followed by stretching in the longitudinal direction (MD direction). The film source 9 after the stretching process will generate an absorption axis direction A9 in the stretching direction (namely, MD direction), as shown in FIG. 6A.

In a conventional liquid crystal panel of the TN mode, the absorption axis direction A9a of the visible-side polarizer 31a is arranged to be approximately 135 degrees relative to the longer side direction L of the liquid crystal cell 21, and the absorption axis direction A9b of the antivisible-side polarizer 41b is arranged to be approximately perpendicular relative to the longer side direction L, as shown in FIG. 6B. The polarizers used in such a conventional liquid crystal panel are produced by cutting a film source 9 obliquely as shown in FIG. 6A. Therefore, unnecessary film chips (withdrawal dust) will be plenty in obtaining the polarizers from the film source 9.

Further, since the polarizers are obtained by cutting the film source 9 obliquely, the longer side of the polarizers will typically be shorter than the length in the width direction (the length in the TD direction) of the film source 9. For this reason, the visible surface size of the conventional liquid crystal panel of the TN mode is restricted by the width length of the film source 9, and this width length has been a limit in increasing the scale of the visible surface size.

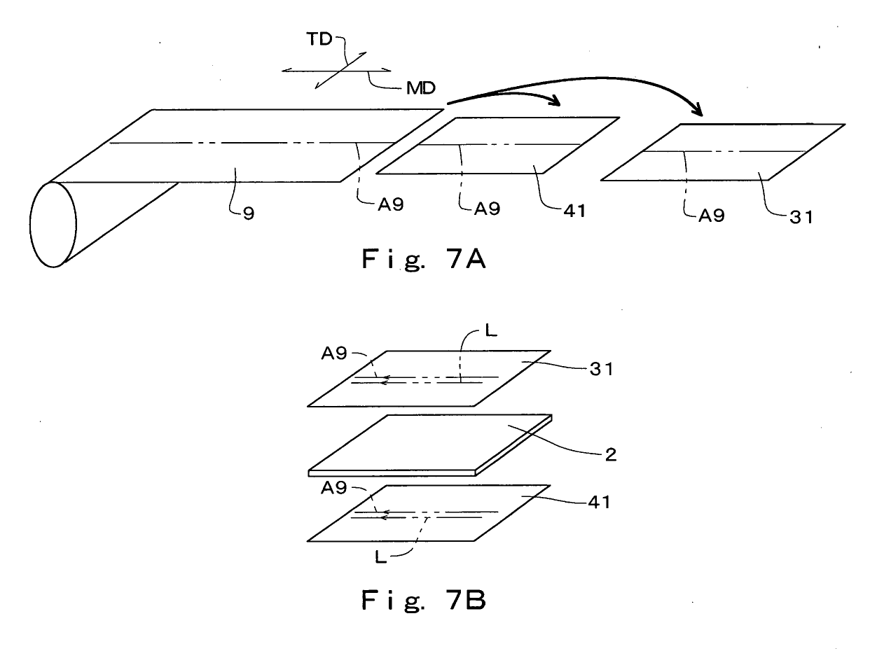

In the “liquid crystal panel of parallel arrangement type” of the present invention, the absorption axis direction of the visible-side polarizer and the absorption axis direction of the antivisible-side polarizer are arranged to be approximately parallel to each other. These two polarizers are obtained by cutting so that the longitudinal direction of the film source 9 will be the longer side of the two rectangular-shaped polarizers 31 and 41, as shown in FIG. 7A. The obtained two polarizers 31 and 41 are respectively arranged on the two sides of the liquid crystal cell 2 so that the absorption axis directions A9 thereof will be approximately parallel to the longer side direction L of the liquid crystal cell 2, as shown in FIG. 7B.

Therefore, the length of the longer side of the visible surface of the above-described liquid crystal panel corresponds to the length in the longitudinal direction of the film source, and the length of the shorter side of the visible surface of the liquid crystal panel corresponds to the length in the width direction of the film source.

For this reason, the “liquid crystal panel of parallel arrangement type” of the present invention can increase the scale of the visible surface size (for example, 20 inches or more) as compared with the above-described conventional liquid crystal panel.

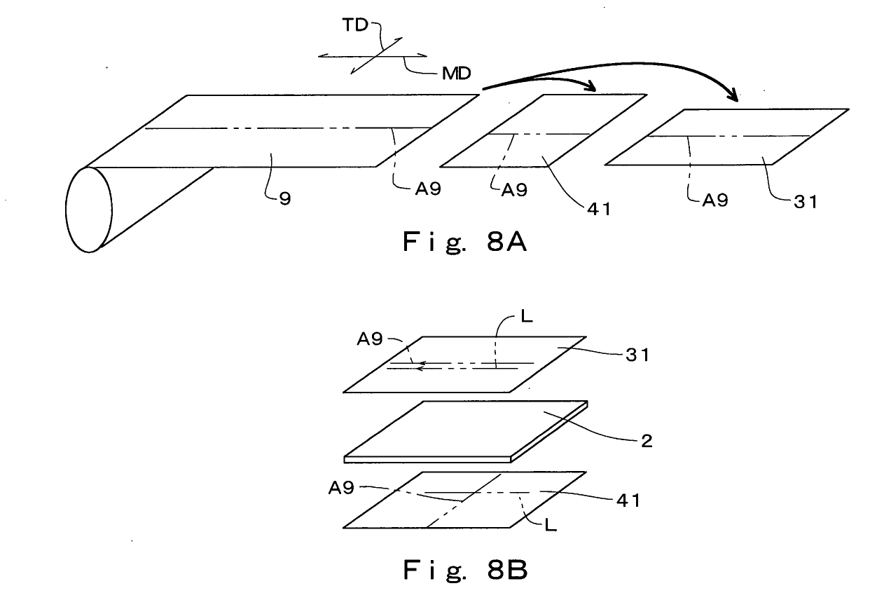

Further, in the “liquid crystal panel of perpendicular arrangement type” of the present invention, the absorption axis direction of the visible-side polarizer is arranged to be approximately perpendicular or approximately parallel relative to the longer side direction of the liquid crystal cell, whereas the absorption axis direction of the antivisible-side polarizer is arranged to be approximately perpendicular to the absorption axis direction of this visible-side polarizer. In the case of this liquid crystal panel, the visible-side polarizer 31 is obtained by cutting so that the longitudinal direction (MD direction) of the film source 9 will be the longer side of the rectangular-shaped polarizer 31, as shown in FIG. 8A. On the other hand, the antivisible-side polarizer 41 is obtained by cutting so that the longitudinal direction of the film source 9 will be the shorter side of the rectangular-shaped polarizer 41. The obtained two polarizers 31 and 41 are respectively arranged on the two sides of the liquid crystal cell 2 so that the absorption axis direction A9 of the visible-side polarizer 31 will be approximately parallel to the longer side direction L of the liquid crystal cell 2, and the absorption axis direction A9 of the antivisible-side polarizer 41 will be approximately perpendicular to the longer side direction L of the liquid crystal cell 2, as shown in FIG. 8B, for example.

In producing the polarizers used in such a “liquid crystal panel of perpendicular arrangement type”, there is no need to cut the film source in an oblique direction as in the above-described conventional liquid crystal panel, thereby preventing unnecessary use of the film.

However, it is to be noted that, in FIGS. 7B and 8B, the polarization rotating layers and the optical compensating layers are not drawn.

Also, FIGS. 6A, 7A, and 8A exemplify a case in which one sheet of a polarizer is cut out from a film source 9 having a predetermined width; however, two or more sheets of polarizers may be cut out in the width direction of the film source 9 in accordance with the length in the width direction of the film source 9 or the size of the polarizers (namely, two or more columns of polarizers may be cut out from the film source 9 having a predetermined width).

### <About the Liquid Crystal Display Device>

The liquid crystal panel of the present invention can be preferably used for forming a liquid crystal display device or the like. Formation of the liquid crystal display device can be carried out in accordance with the prior art. Namely, the liquid crystal display device is formed typically by suitably assembling a liquid crystal panel and construction components such as an illumination system, or the like process. The liquid crystal display device of the present invention is not particularly limited except that the aforesaid liquid crystal panel is used, so that it can be fabricated according to the prior art.

The liquid crystal display device of the present invention is used for arbitrary purposes. The use thereof is directed, for example, to OA appliance such as personal computer monitors, notebook personal computers, and copying machines, portable appliance such as portable phones, watches, digital cameras, portable information terminals (PDA), and portable game machines, electric appliance for home use such as video cameras, television sets, and electronic ranges, appliance for mounting on a vehicle such as back monitors, monitors for a car navigation system, and car audio apparatus, display appliance such as monitors for information for commercial stores, safeguard appliance such as supervising monitors, assisting or medical appliance such as monitors for assisting and caring seniors and monitors for medical use, and the like appliance.

What is claimed is:

1. A liquid crystal panel comprising:
a liquid crystal cell;
a visible-side polarizer disposed on a visible surface side of the liquid crystal cell; and
an antivisible-side polarizer disposed on a side opposite to the visible surface of the liquid crystal cell, wherein
the visible-side polarizer and the antivisible-side polarizer are disposed so that an absorption axis direction of the visible-side polarizer and an absorption axis direction of the antivisible-side polarizer are approximately parallel to each other, and
a polarization rotating layer that rotates linearly polarized light by approximately 45 degrees is disposed respectively between the visible-side polarizer and the liquid crystal cell and between the antivisible-side polarizer and the liquid crystal cell.

2. The liquid crystal panel of claim 1, wherein the visible-side polarizer and the antivisible-side polarizer are disposed so that the absorption axis direction of the visible-side polarizer and the absorption axis direction of the antivisible-side polarizer will be approximately parallel to a longer side direction of the liquid crystal cell.

3. The liquid crystal panel of claim 1, wherein the liquid crystal cell is in a normally white mode.

4. The liquid crystal panel of claim 1, wherein the liquid crystal cell is in a TN mode.

5. The liquid crystal panel of claim 1, wherein the visible-side polarizer and the antivisible-side polarizer include a stretched film that generates an absorption axis in a main stretching direction.

6. The liquid crystal panel of claim 1, wherein the visible-side polarizer and the antivisible-side polarizer include a stretched film containing the same resin as a major component.

7. The liquid crystal panel of claim 1, wherein the polarization rotating layer is a ½ wavelength plate.

8. The liquid crystal panel of claim 7, wherein the ½ wavelength plate has a refractive index property of any one of nx₁>ny₁>nz₁, nx₁>ny₁≈nz₁, and nx₁>nz₁>ny₁, where
nx₁ represents a refractive index in an X-axis direction in a plane of the ½ wavelength plate,
ny₁ represents a refractive index in a Y-axis direction in the same plane, and
nz₁ represents a refractive index in a direction perpendicular to said X-axis direction and Y-axis direction, wherein
the X-axis direction is an axis direction in which the refractive index attains a maximum value in the plane, and
the Y-axis direction is a direction perpendicular to an X-axis in the plane.

9. The liquid crystal panel of claim 1, wherein the polarization rotating layer has a liquid crystal material that has been subjected to cholesteric orientation.

10. The liquid crystal panel of claim 9, wherein the polarization rotating layer contains 0.005 to 0.1 part by weight of a chiral agent with respect to 100 parts by weight of a nematic liquid crystal material.

11. The liquid crystal panel of claim 1, wherein an optical compensating layer showing a predetermined retardation is disposed between the visible-side polarizer and the antivisible-side polarizer.

12. A liquid crystal display device having the liquid crystal panel of claim 1.

13. A liquid crystal panel comprising:
a liquid crystal cell;
a visible-side polarizer disposed on a visible surface side of the liquid crystal cell; and
an antivisible-side polarizer disposed on a side opposite to the antivisible surface of the liquid crystal cell, wherein
the visible-side polarizer is disposed so that an absorption axis direction of the visible-side polarizer will be approximately perpendicular to or approximately parallel to a longer side direction of the liquid crystal cell,
the antivisible-side polarizer is disposed so that an absorption axis direction of the antivisible-side polarizer will be approximately perpendicular to the absorption axis direction of the visible-side polarizer, and
a polarization rotating layer that rotates linearly polarized light by approximately 45 degrees is disposed respectively between the visible-side polarizer and the liquid crystal cell and between the antivisible-side polarizer and the liquid crystal cell.

14. The liquid crystal panel of claim 13, wherein the visible-side polarizer is disposed so that the absorption axis direction thereof will be approximately parallel to the longer side direction of the liquid crystal cell.

15. The liquid crystal panel of claim 13, wherein the liquid crystal cell is in a normally white mode.

16. The liquid crystal panel of claim 13, wherein the liquid crystal cell is in a TN mode.

17. The liquid crystal panel of claim 13, wherein the visible-side polarizer and the antivisible-side polarizer include a stretched film that generates an absorption axis in a main stretching direction.

18. The liquid crystal panel of claim 13, wherein the visible-side polarizer and the antivisible-side polarizer include a stretched film containing the same resin as a major component.

19. The liquid crystal panel of claim 13, wherein the polarization rotating layer is a ½ wavelength plate.

20. The liquid crystal panel of claim 19, wherein the ½ wavelength plate has a refractive index property of any one of nx₁>ny₁>nz₁, nx₁>ny₁≈nz₁, and nx₁>nz₁>ny₁, where
nx₁ represents a refractive index in an X-axis direction in a plane of the ½ wavelength plate,
ny₁ represents a refractive index in a Y-axis direction in the plane, and
nz₁ represents a refractive index in a direction perpendicular to said X-axis direction and Y-axis direction, wherein
the X-axis direction is an axis direction in which the refractive index attains a maximum value in the plane, and
the Y-axis direction is a direction perpendicular to an X-axis in the plane.

21. The liquid crystal panel of claim 13, wherein the polarization rotating layer has a liquid crystal material that has been subjected to cholesteric orientation.

22. The liquid crystal panel of claim 21, wherein the polarization rotating layer contains 0.005 to 0.1 part by weight of a chiral agent with respect to 100 parts by weight of a nematic liquid crystal material.

23. The liquid crystal panel of claim 13, wherein an optical compensating layer showing a predetermined retardation is disposed between the visible-side polarizer and the antivisible-side polarizer.

24. A liquid crystal display device having the liquid crystal panel of claim 13.
